(19) United States
(12) Patent Application Publication
(10) Pub. No.: US 2025/0039977 A1
(43) Pub. Date: Jan. 30, 2025

(54) DISCONTINUOUS RECEPTION (DRX) IMPLEMENTATION BASED ON USER EQUIPMENT (UE) SCENARIO

(71) Applicant: QUALCOMM Incorporated, San Diego, CA (US)

(72) Inventors: Wei GU, Wuxi (CN); Hua XU, Shanghai (CN); Zhongliang ZHANG, Shanghai (CN); Yuankun ZHU, Shanghai (CN); Chaohui DONG, Shanghai (CN); Jianhua LIU, Shanghai (CN)

(21) Appl. No.: 18/715,606

(22) PCT Filed: Feb. 10, 2022
(86) PCT No.: PCT/CN2022/075809

§ 371 Date: May 31, 2024

(51) Int. Cl. H04W 76/28

(52) U.S. Cl. CPC H04W 76/28

(57) ABSTRACT

Certain aspects of the present disclosure provide techniques for wireless communication by a user equipment (UE). The UE detects one or more conditions are satisfied during a streaming session during which the UE buffers downlink data for playback. The UE transmits, to a network entity, a request to change a connected mode discontinuous reception (CDRX) cycle based on detecting the one or more conditions are satisfied.

Aspects of the present disclosure relate to wireless communications, and more particularly, to techniques for managing a discontinuous reception (DRX) cycle.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by user equipment (UE), comprising: detecting one or more conditions are satisfied during a streaming session during which the UE buffers downlink data for playback; and transmitting, to a network entity, a request to change a connected mode discontinuous reception (CDRX) cycle based on detecting the one or more conditions are satisfied.

Another aspect provides a method for wireless communication by a network entity, comprising: receiving, from a UE, a request to change a CDRX cycle that was generated by the UE after the UE detected one or more conditions at the UE are satisfied; and changing the CDRX cycle based on the request.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station (BS) and user equipment (UE).

FIGS. 3A-3D depict various example aspects of data structures for a wireless communication network.

FIG. 4A illustrates example timeline for discontinuous reception (DRX) cycles.

FIG. 4B illustrates example timeline for connected mode DRX (C-DRX) operation.

FIG. 5 illustrates example online streaming data throughput pattern.

FIG. 6A illustrates example DRX configuration.

FIG. 6B illustrates example CDRX wakeup scenario.

FIG. 7 is a call flow diagram illustrating example communication between a UE and a network entity.

FIG. 8 illustrates example power saving of a UE for a first CDRX configuration (e.g., with a short CDRX cycle) and a second CDRX configuration (e.g., without the short CDRX cycle).

FIG. 9 illustrates example UE power consumption measurement for a first CDRX configuration (e.g., with a long CDRX cycle) and a second CDRX configuration (e.g., with a short CDRX cycle and the long CDRX cycle).

FIG. 10 is a flow diagram illustrating example operations for wireless communication by a UE.

FIG. 11 is a flow diagram illustrating example operations for wireless communication by a network entity.

FIG. 12 depicts aspects of an example communications device.

FIG. 13 depicts aspects of an example communications device.

FIG. 14 depicts an example disaggregated BS architecture.

### DETAILED DESCRIPTION

Aspects of the present disclosure provide apparatuses, methods, processing systems, and computer-readable mediums for managing a discontinuous reception (DRX) mode based on a user equipment (UE) scenario. For example, techniques may be used to manage a connected mode DRX (CDRX) cycle based on a condition detected while the UE is participating in an online streaming session.

CDRX aims to improve UE battery power consumption by allowing the UE to periodically enter a low power sleep state (e.g., CDRX Off duration) during which the UE does not need to monitor for physical downlink control channel (PDCCH) transmissions. The UE exits the sleep state in order to monitor the PDCCH for possible downlink or uplink data (e.g., during a CDRX On duration). Certain configured CDRX modes may be less than ideal for certain UE scenarios.

For example, during a video streaming session, a UE may buffer certain downlink data for playback on the UE. Once the certain downlink data is buffered, the UE may not receive any other data for some time. Normally, the UE may enter a sleep/CDRX cycle mode during this time gap when no other data is being received, to save power. However, in some cases, when the UE is configured with short CDRX cycle parameters (e.g., 3 cycles and 40 ms periodicity), the UE may be unable to enter into deep sleep during the whole CDRX cycle (including during the time gap). This may result in significant power consumption by the UE (e.g., due to an increase in time spent awake).

Techniques described herein disable a short CDRX cycle during an online streaming session (e.g., when certain conditions are satisfied by a UE). When the short CDRX cycle is disabled, wakeup time of the UE is reduced and sleep time of the UE is increased. As a result, the techniques described herein may help reduce power consumption by the UE.

### Introduction to Wireless Communication Networks

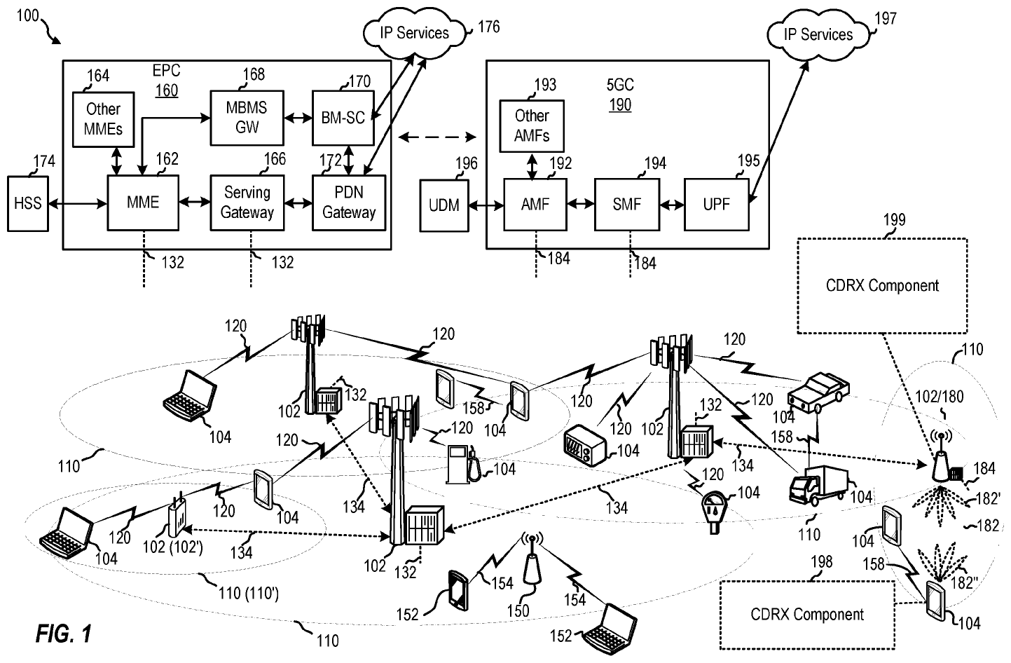

FIG. 1 depicts an example of a wireless communication network 100, in which aspects described herein may be implemented.

Generally, wireless communication network 100 includes base stations (BSs) 102, user equipments (UEs) 104 (e.g., having one or more radar devices), one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs may include and/or be referred to as a gNB, NodeB, eNB, ng-eNB (e.g., an eNB that has been enhanced to provide connection to both EPC 160 and 5GC 190), an access point, a base transceiver station, a radio BS, a radio transceiver, or a transceiver function, or a transmission reception point in various contexts.

A BS, such as BS 102, may include components that are located at a single physical location or components located at various physical locations. In examples in which the BS includes components that are located at various physical locations, the various components may each perform various functions such that, collectively, the various components achieve functionality that is similar to a BS that is located at a single physical location. As such, a BS may equivalently refer to a standalone BS or a BS including components that are located at various physical locations or virtualized locations. In some implementations, a BS including components that are located at various physical locations may be referred to as or may be associated with a disaggregated radio access network (RAN) architecture, such as an Open RAN (O-RAN) or Virtualized RAN (VRAN) architecture. In some implementations, such components of a BS may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power BS) may have a coverage area 110′ that overlaps the coverage area 110 of one or more macrocells (e.g., high-power BSs).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming.

In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

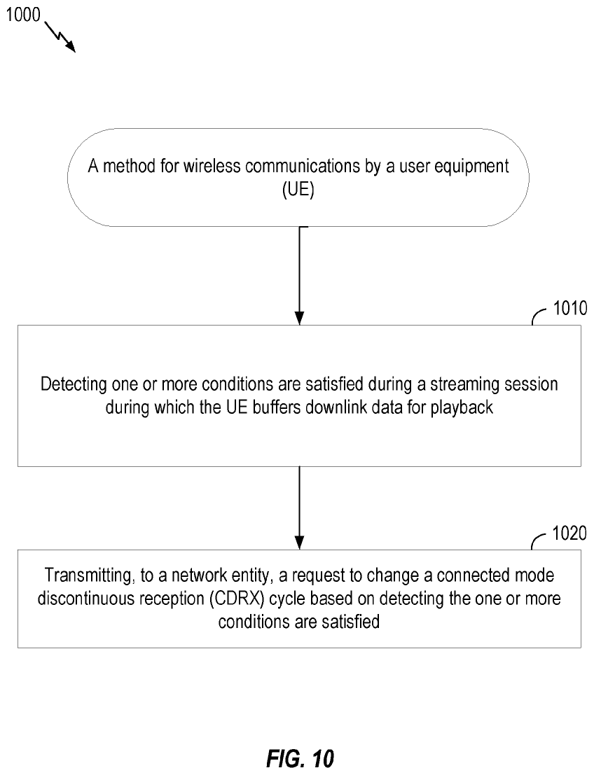

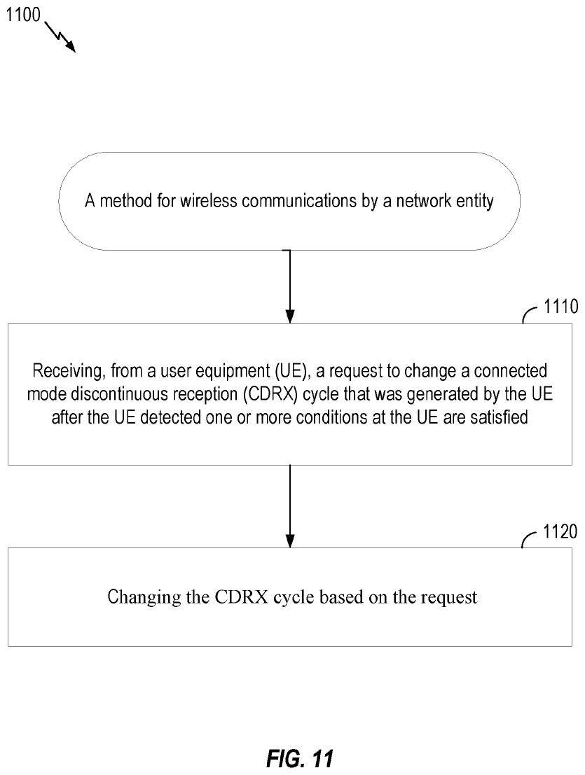

Wireless communication network 100 further includes connected mode discontinuous reception (CDRX) component 198, which may be configured to perform operations 1000 of FIG. 10. Wireless communication network 100 includes CDRX component 199, which may be configured to perform operations 1100 of FIG. 11.

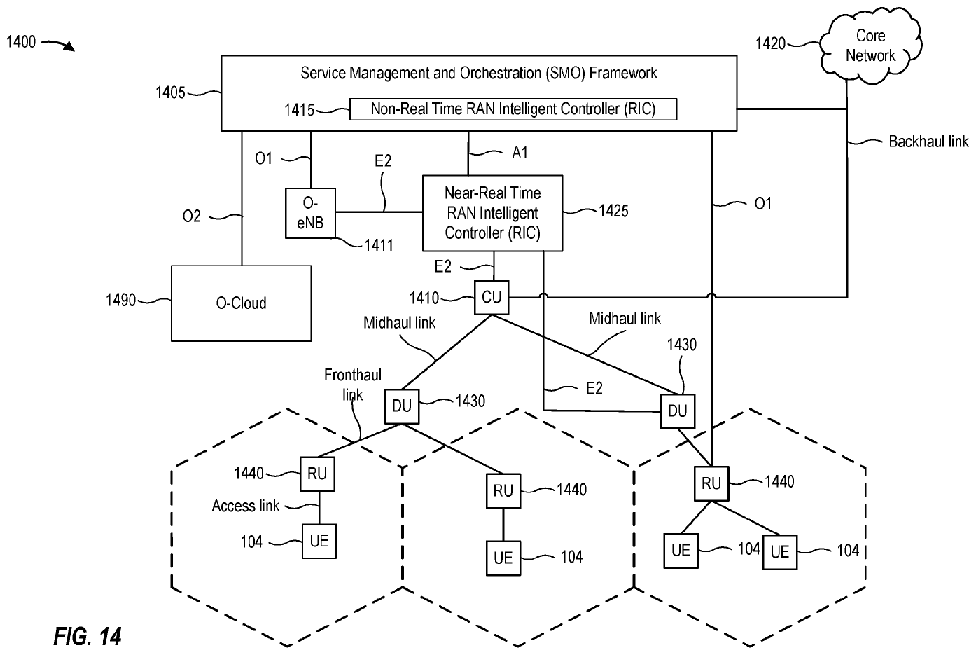

In various aspects, a BS 180 or a network node can be implemented as an aggregated BS, a disaggregated BS, an integrated access and backhaul (IAB) node, a relay node, or a sidelink node, to name a few examples. FIG. 14, discussed in further detail later in this disclosure, depicts an example disaggregated BS architecture.

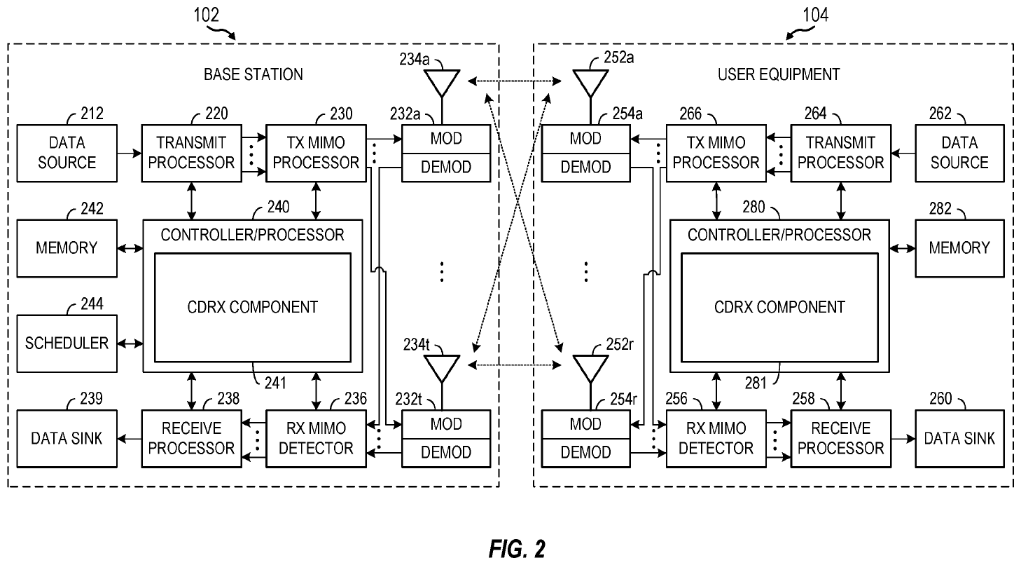

FIG. 2 depicts aspects of an example BS 102 and a UE 104 (e.g., having a radar device). Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes CDRX component 241, which may be representative of CDRX component 199 of FIG. 1. Notably, while depicted as an aspect of controller/processor 240, CDRX component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes CDRX component 281, which may be representative of CDRX component 198 of FIG. 1. Notably, while depicted as an aspect of controller/processor 280, CDRX component 281 may be implemented additionally or alternatively in various other aspects of UE 104 in other implementations.

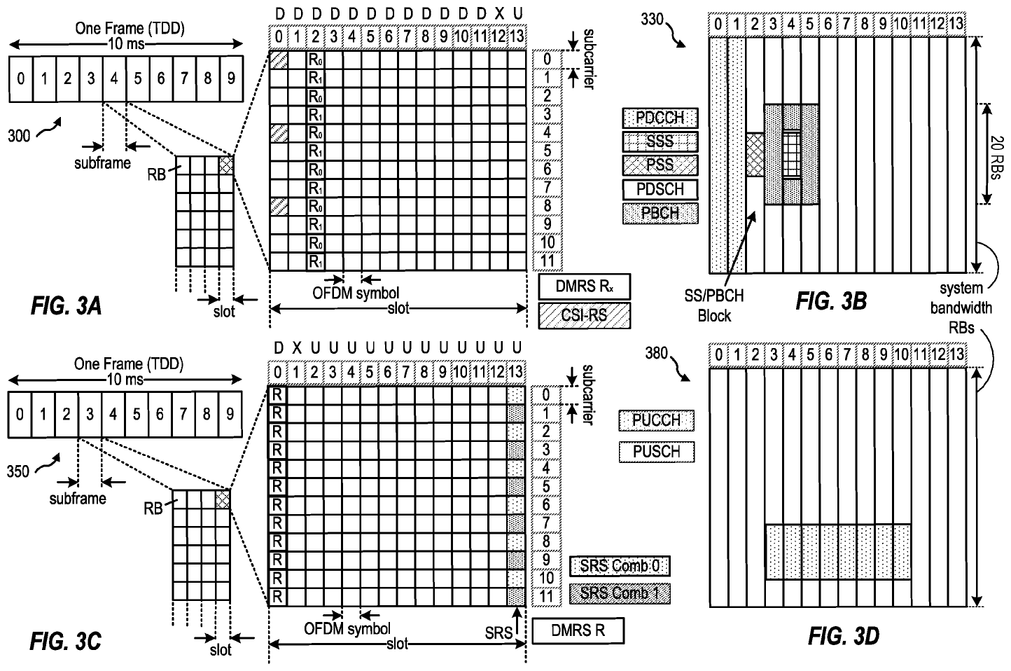

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

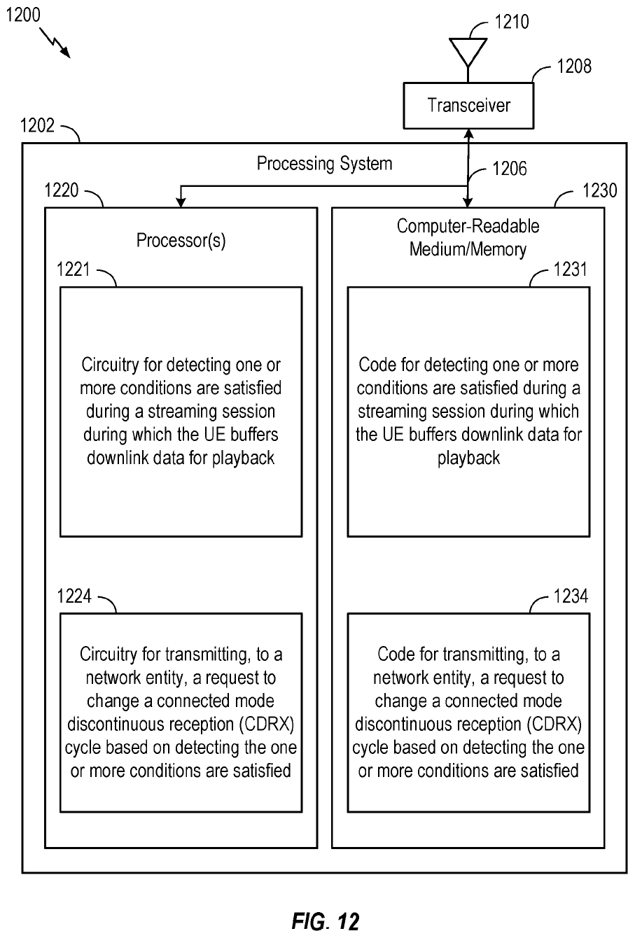

Further discussions regarding FIG. 1, FIG. 2, FIGS. 3A-3D, and FIG. 12 are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHZ-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., BS 180) configured to communicate using mmWave/near mmWave radio frequency bands may utilize beamforming (e.g., 182) with a user equipment (UE) (e.g., UE 104) to improve path loss and range.

### Introduction to Connected Discontinuous Reception (CDRX)

Connected mode discontinuous reception (CDRX) improves user equipment (UE) battery power consumption by allowing the UE to periodically enter sleep state (e.g., OFF duration) during which physical downlink control channel (PDCCH) need not be monitored. In order to monitor the PDCCH for possible downlink/uplink data, the UE is allowed to wake up periodically and stay awake (e.g., ON duration) for a certain amount of time before going to sleep again.

A network entity configures the UE with a set of CDRX parameters. The CDRX parameters may be selected based on an application type such that power and resource savings are maximized. When the CDRX is enabled, the UE power consumption is reduced.

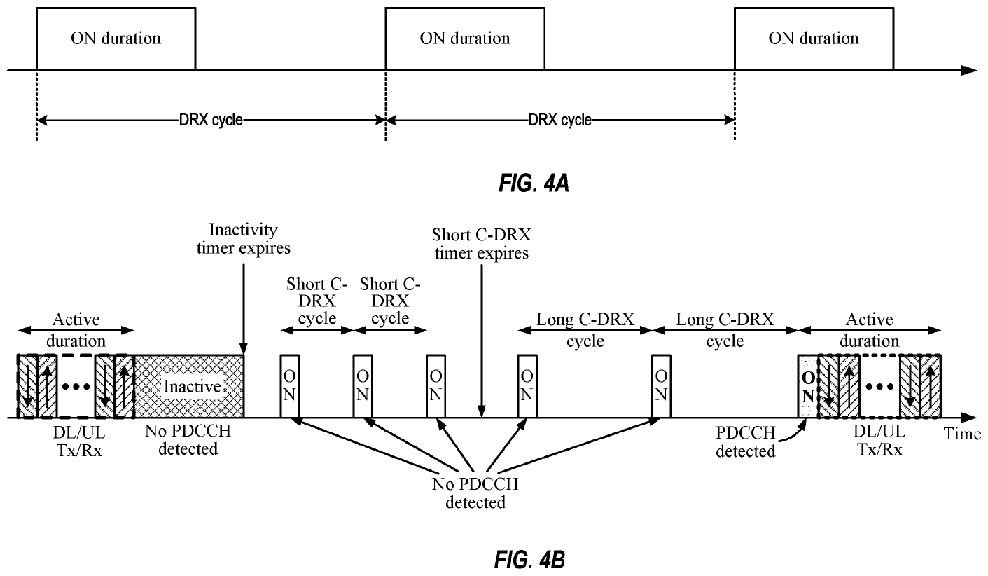

As illustrated in FIG. 4A and FIG. 4B, during periods of traffic inactivity, a UE switches to a CDRX operation for power saving. The UE is configured for the CDRX operation according to various configuration parameters, such as an inactivity timer, a short DRX (discontinuous reception) timer, a short DRX cycle, and a long DRX cycle.

The long DRX cycle may be characterized by active state and sleep states. The long DRX cycle may not suitable for certain services, which require periods of data transmission followed by periods of no activity. In such cases, a network entity has the flexibility to configure the long DRX cycle together with an additional DRX cycle, which is shorter compared to the long DRX cycle. This additional DRC cycle is the short DRX cycle.

When the network entity has configured the short DRX cycle, it means both long and short DRX cycles are configured. In some cases, configuring the short DRX cycle is optional and if not configured, the UE follows the long DRX cycle as usual. Whenever the network entity configures the short DRX cycle, the network entity ensures that the long DRX cycle duration is an integer multiple of the short DRX cycle duration. This means, the short DRX cycle duration is shorter than the long DRX cycle duration.

Based on configured CDRX cycles, the UE wakes up occasionally for ON durations and monitors for PDCCH transmissions. Except for the ON durations, the UE may remain in a low power (sleep) state referred to as an OFF duration, for the rest of CDRX cycle. During the OFF duration, the UE is not expected to transmit and receive any signal.

In a CDRX mode, the UE wakes up and transmits and/or receives (TX/RX) data packets following CDRX cycle (during the CDRX ON period). In some cases, if the UE detects a PDCCH scheduling data during the ON duration, the UE remains ON to transmit and receive data. Otherwise, the UE goes back to sleep at the end of the ON duration. This type of the CDRX mode has been used many years and is still default behavior of some new radio (NR) networks and UEs.

In some cases, with periodic CDRX cycles, the UE may wake up frequently even when the UE has no data to transmit and/or to monitor for data (e.g., indicated by a page), which wastes UE power. Enlarging the CDRX cycle may cause UEs to wake up less often, but this may also lead to increased data service latency (e.g., if the UE has data packets to transmit well before the next CDRX ON duration). This is because, there might be an extended delay in receiving data as, the UE may be in sleep state at the time of data arrival. The latency increases with CDRX cycle length, i.e., the longer the CDRX cycle length, the higher the latency is. So, the CDRX parameters are selected such that the packet delay is minimized, and power saving is maximized.

### Example Wakeup Time of UE During Online Streaming Session

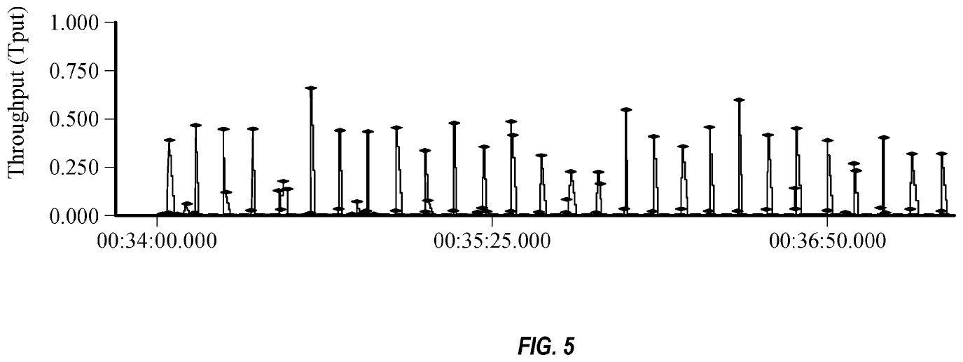

As noted above, in some scenarios (e.g., during an online streaming session), the UE may buffer certain downlink data (e.g., video and/or audio data) for playback on the UE. Once the certain downlink data is buffered, the UE may not receive any other data for some time. For example, as illustrated in online streaming data throughput (Tput) pattern of FIG. 5, active data is received by the UE after a certain time gap during the online streaming session.

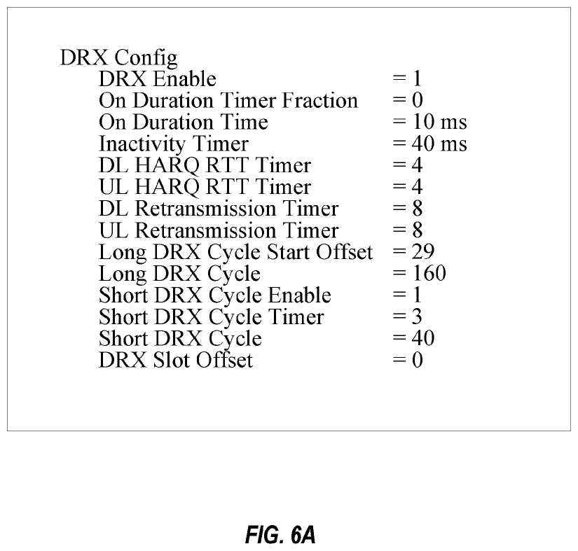

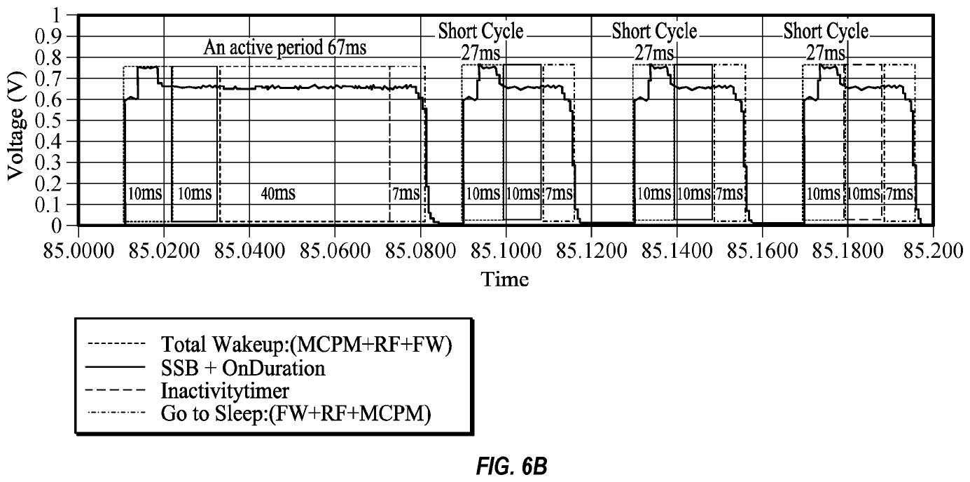

The UE may enter a sleep mode during this time gap when no other data is being received by the UE. However, when the UE is configured with short CDRX cycle parameters (e.g., 3 cycles and 40 ms periodicity, as illustrated in FIG. 6A), the UE is unable to enter into a deep sleep during a whole CDRX cycle (including during the time gap). This causes a big power consumption by the UE (e.g., due to more wakeup time and less sleep time). Accordingly, although the purpose of the short CDRX cycle is to balance the UE battery power consumption and the latency, however, during the online streaming session, the short CDRX cycle is not helpful and increases power consumption by the UE. For example, as illustrated in FIG. 6B, a total wakeup time of the UE is 121 milliseconds (ms) in 160 ms cycle (e.g., during the online streaming session) due to at least multiple short CDRX cycles.

### Aspects Related to Smart CDRX Implementation Based on UE Scenario

Aspects of the present disclosure provide apparatuses, methods, processing systems, and computer-readable mediums for managing a connected mode discontinuous reception (CDRX) cycle, based on a user equipment (UE) scenario. For example, according to certain techniques described herein, a UE may request that a network entity disable a short CDRX cycle, during an online streaming session at a UE, when certain conditions are satisfied. When the short CDRX cycle is disabled, wakeup time of the UE may be reduced, resulting in an increase of sleep time and a corresponding reduction in UE power consumption.

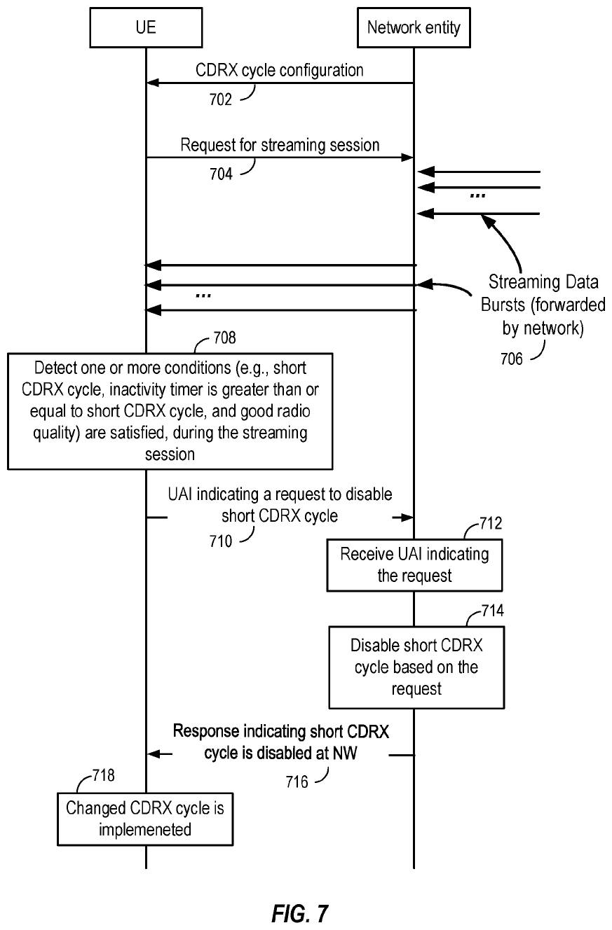

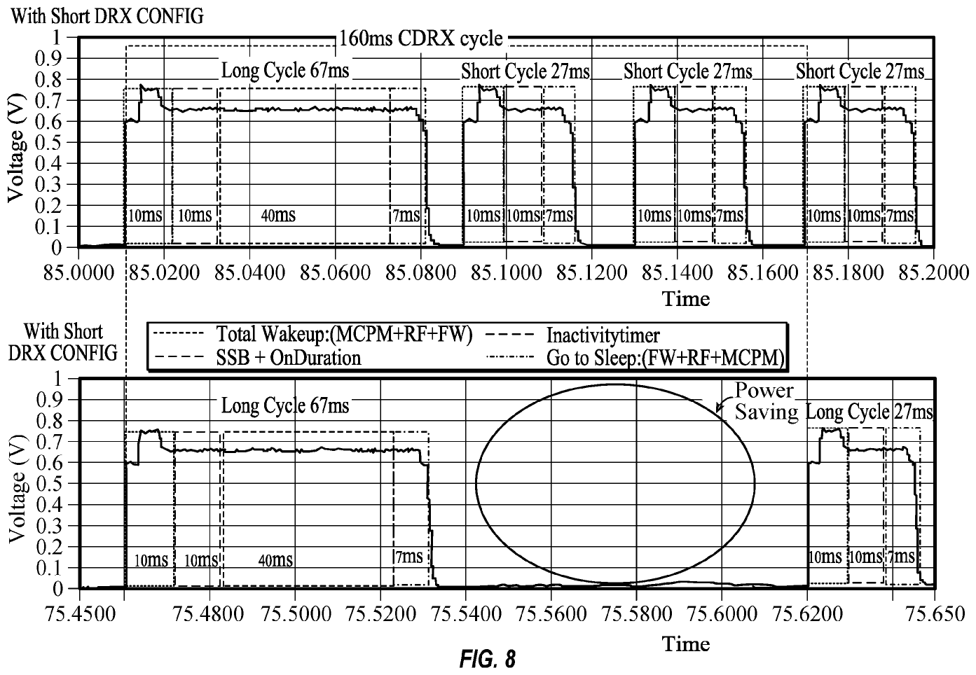

The techniques for managing a CDRX cycle proposed herein may be understood with reference to the FIGS. 7-11.

As illustrated in FIG. 7, at 702, a network entity sends a CDRX cycle configuration to a UE. The CDRX cycle configuration is associated with one or more configuration features. In one example, a configuration feature is an inactivity timer. In another example, a configuration feature is a short CDRX cycle. In another example, a configuration feature is a long CDRX cycle.

At 704, the UE sends a request for a streaming session (e.g., online video streaming from an application client) to the network entity.

At 706, the network entity transmits streaming data bursts to the UE, in response to the request. In certain aspects, the network entity may forward the request to the application client, and may receive the streaming data bursts from the application client.

At 708, the UE detects one or more conditions are satisfied during the streaming session.

For example, during the streaming session, the UE may detect the UE is configured with one or more parameters (e.g., a number of cycles, a periodicity, etc.) associated with a first duration of the CDRX cycle (e.g., a short CDRX cycle). A second duration of the CDRX cycle (e.g., a long CDRX cycle) is longer than the first duration of the CDRX cycle.

In another example, the UE may detect a duration of the inactivity timer is more than or equal to the short CDRX cycle.

In another example, the UE may detect that quality of a channel (e.g., between the UE and the network entity) is more than or equal to a predetermined threshold. A value of the predetermined threshold is pre-stored in the UE. The UE determines the quality (e.g., radio quality) of the channel based on a reference signal received power (RSRP), a reference signal received quality (RSRQ), a reference signal strength indicator (RSSI), channel quality information (CQI), and/or a block error rate (BLER).

At 710, the UE transmits a request to the network entity via UE assistance information (UAI). The request is to change the CDRX cycle (e.g., disable the short CDRX cycle).

At 712, the network entity receives the UAI indicating the request.

At 714, the network entity disables the short CDRX cycle based on the request.

At 716, the network entity transmits a response indicating that the short CDRX cycle has been disabled (e.g., at the network entity) to the UE.

At 718, the UE implements a changed CDRX cycle (e.g., without a short CDRX cycle configuration).

In certain aspects, when the UE implements the changed CDRX cycle, wakeup time of the UE is reduced and sleep time of the UE is increased. For example, as illustrated in FIG. 8, a total wakeup time of the UE is 67 milliseconds (ms) in 160 ms cycle during the streaming session (e.g., when there are no short CDRX cycles), and a total wakeup time of the UE is 121 ms in 160 ms cycle (e.g., when there are short CDRX cycles). Accordingly, power saving of the UE, when the short CDRX cycle is not configured, is substantial due to less total wakeup time.

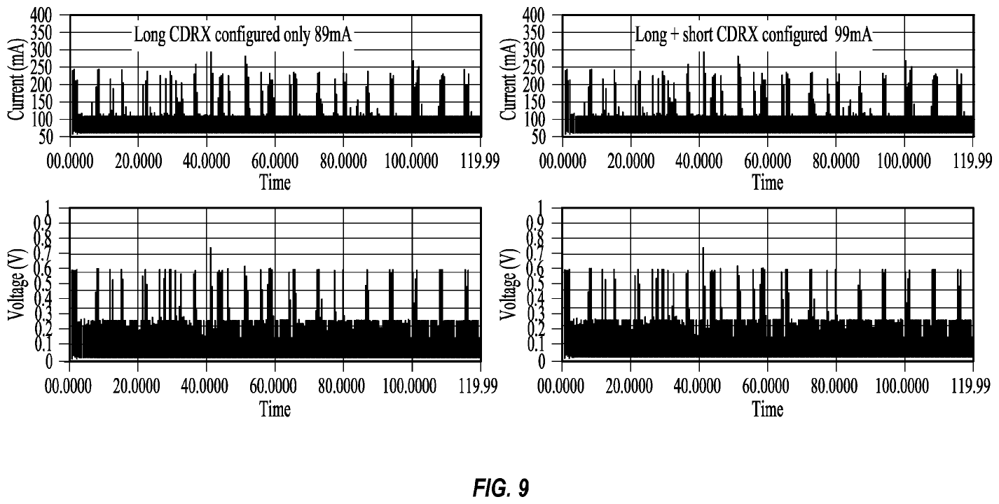

In certain aspects, the UE configured with only the long CDRX cycle may consume less power during an online audio streaming session, as compared to when configured with both the short CDRX cycle and the long CDRX cycle. For example, as illustrated in FIG. 9, a total power consumption of the UE is 89 mill ampere (mA) during the online audio streaming session (e.g., when there is only long CDRX cycle), and a total power consumption of the UE is 99 mA during the online audio streaming session (e.g., when there is the short CDRX cycle and the long CDRX cycle). Accordingly, power saving of the UE, when the short CDRX cycle is not configured, is substantial.

FIG. 10 illustrates example operations 1000 for wireless communication. The operations 1000 may be performed, for example, by a UE (e.g., such as UE 104 in wireless communication network 100 of FIG. 1). The operations 1000 may be implemented as software components that are executed and run on one or more processors (e.g., controller/processor 280 of FIG. 2). Further, transmission and reception of signals by the UE in the operations 1000 may be enabled, for example, by one or more antennas (e.g., antennas 252 of FIG. 2). In certain aspects, the transmission and/or reception of signals by the UE may be implemented via a bus interface of one or more processors (e.g., the controller/processor 280) obtaining and/or outputting signals.

The operations 1000 begin, at 1010, by detecting one or more conditions are satisfied during a streaming session during which the UE buffers downlink data for playback. For example, the UE may detect the one or more conditions are satisfied using a processor of UE 104 shown in FIG. 1 or FIG. 2 and/or of the apparatus shown in FIG. 12.

At 1020, the UE transmits, to a network entity, a request to change a CDRX cycle based on detecting the one or more conditions are satisfied. For example, the UE may transmit the request using antenna(s) and/or transmitter/transceiver components of UE 104 shown in FIG. 1 or FIG. 2 and/or of the apparatus shown in FIG. 12.

FIG. 11 illustrates example operations 1100 for wireless communication. The operations 1100 may be performed, for example, by a network entity (e.g., such as BS 102 in wireless communication network 100 of FIG. 1). The operations 1100 may be implemented as software components that are executed and run on one or more processors (e.g., controller/processor 240 of FIG. 2). Further, transmission and reception of signals by the network entity in the operations 1100 may be enabled, for example, by one or more antennas (e.g., antennas 234 of FIG. 2). In certain aspects, the transmission and/or reception of signals by the network entity may be implemented via a bus interface of one or more processors (e.g., the controller/processor 240) obtaining and/or outputting signals.

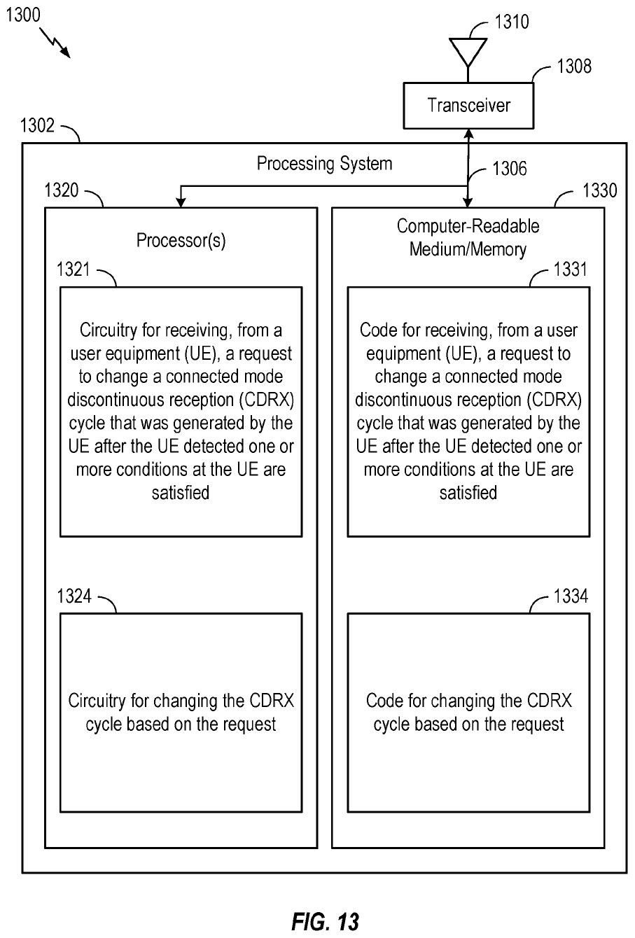

The operations 1100 begin, at 1110, by receiving, from a UE, a request to change a CDRX cycle that was generated by the UE after the UE detected one or more conditions at the UE are satisfied. For example, the network entity may receive the request using antenna(s) and/or receiver/transceiver components of BS 102 shown in FIG. 1 or FIG. 2 and/or of the apparatus shown in FIG. 13.

At 1120, the network entity changes the CDRX cycle based on the request. For example, the network entity may change the CDRX cycle using a processor of BS 102 shown in FIG. 1 or FIG. 2 and/or of the apparatus shown in FIG. 13.

### Example Wireless Communication Devices

FIG. 12 depicts an example communications device 1200 that includes various components operable, configured, or adapted to perform operations for the techniques disclosed herein, such as the operations depicted and described with respect to FIG. 10. In some examples, communication device 1200 may be a UE 104 (comprising a radar device) as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIG. 10, or other operations for performing the various techniques discussed herein.

In the depicted example, computer-readable medium/memory 1230 stores code 1231 for detecting one or more conditions are satisfied during a streaming session during which the UE buffers downlink data for playback, and code 1234 for transmitting, to a network entity, a request to change a connected mode discontinuous reception (CDRX) cycle based on detecting the one or more conditions are satisfied.

In the depicted example, the one or more processors 1220 include circuitry configured to implement the code stored in the computer-readable medium/memory 1230, including circuitry 1221 for detecting one or more conditions are satisfied during a streaming session during which the UE buffers downlink data for playback, and circuitry 1224 for transmitting, to a network entity, a request to change a CDRX cycle based on detecting the one or more conditions are satisfied.

Various components of communications device 1200 may provide means for performing the methods described herein, including with respect to FIG. 10.

In some examples, means for transmitting or sending (or means for outputting for transmission) may include the transceivers 254 and/or antenna(s) 252 of the UE 104 illustrated in FIG. 2 and/or transceiver 1208 and antenna 1210 of the communication device 1200 in FIG. 12.

In some examples, means for receiving (or means for obtaining) may include the transceivers 254 and/or antenna(s) 252 of the UE 104 illustrated in FIG. 2 and/or transceiver 1208 and antenna 1210 of the communication device 1200 in FIG. 12.

In some examples, means for detecting one or more conditions are satisfied during a streaming session during which the UE buffers downlink data for playback, and means for transmitting, to a network entity, a request to change a CDRX cycle based on detecting the one or more conditions are satisfied, may include various processing system components, such as: the one or more processors 1220 in FIG. 12, or aspects of the UE 104 depicted in FIG. 2, including receive processor 258, transmit processor 264, TX MIMO processor 266, and/or controller/processor 280 (including CDRX component 281).

Notably, FIG. 12 is an example, and many other examples and configurations of communication device 1200 are possible.

FIG. 13 depicts an example communications device 1300 that includes various components operable, configured, or adapted to perform operations for the techniques disclosed herein, such as the operations depicted and described with respect to FIG. 11. In some examples, communication device 1300 may be a BS 102 as described, for example with respect to FIGS. 1 and 2.

Communications device 1300 includes a processing system 1302 coupled to a transceiver 1308 (e.g., a transmitter and/or a receiver). Transceiver 1308 is configured to transmit (or send) and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes one or more processors 1320 coupled to a computer-readable medium/memory 1330 via a bus 1306. In certain aspects, computer-readable medium/memory 1330 is configured to store instructions (e.g., computer-executable code) that when executed by the one or more processors 1320, cause the one or more processors 1320 to perform the operations illustrated in FIG. 11, or other operations for performing the various techniques discussed herein.

In the depicted example, computer-readable medium/memory 1330 stores code 1331 for receiving, from a UE, a request to change a CDRX cycle that was generated by the UE after the UE detected one or more conditions at the UE are satisfied, and code 1334 for changing the CDRX cycle based on the request.

In the depicted example, the one or more processors 1320 include circuitry configured to implement the code stored in the computer-readable medium/memory 1330, including circuitry 1321 for receiving, from a UE, a request to change a CDRX cycle that was generated by the UE after the UE detected one or more conditions at the UE are satisfied, and circuitry 1324 for changing the CDRX cycle based on the request.

Various components of communications device 1300 may provide means for performing the methods described herein, including with respect to FIG. 11.

In some examples, means for transmitting or sending (or means for outputting for transmission) may include the transceivers 232 and/or antenna(s) 234 of the BS 102 illustrated in FIG. 2 and/or transceiver 1308 and antenna 1310 of the communication device 1300 in FIG. 13.

In some examples, means for receiving (or means for obtaining) may include the transceivers 232 and/or antenna(s) 234 of the BS illustrated in FIG. 2 and/or transceiver 1308 and antenna 1310 of the communication device 1300 in FIG. 13.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, from a UE, a request to change a CDRX cycle that was generated by the UE after the UE detected one or more conditions at the UE are satisfied, and means for changing the CDRX cycle based on the request, may include various processing system components, such as: the one or more processors 1320 in FIG. 13, or aspects of the BS 102 depicted in FIG. 2, including receive processor 238, transmit processor 220, TX MIMO processor 230, and/or controller/processor 240 (including CDRX component 241).

Notably, FIG. 13 is an example, and many other examples and configurations of communication device 1300 are possible.

### Example Clauses

Implementation examples are described in the following numbered clauses:

Clause 1: A method for wireless communication by a user equipment (UE), comprising: detecting one or more conditions are satisfied during a streaming session during which the UE buffers downlink data for playback; and transmitting, to a network entity, a request to change a connected mode discontinuous reception (CDRX) cycle based on detecting the one or more conditions are satisfied.

Clause 2: The method alone or in combination with the first clause, further comprising receiving, from the network entity, a response indicating disablement of a first duration of the CDRX cycle, based on the request, wherein a second duration of the CDRX cycle is longer than the first duration of the CDRX cycle.

Clause 3: The method alone or in combination with the second clause, wherein detecting the one or more conditions are satisfied comprises: detecting the UE is configured with one or more parameters associated with the first mode of the CDRX cycle.

Clause 4: The method alone or in combination with the second clause, wherein detecting the one or more conditions are satisfied comprises: detecting a duration of an inactivity timer is more than or equal to the first duration of the CDRX cycle.

Clause 5: The method alone or in combination with the first clause, wherein detecting the one or more conditions are satisfied comprises: detecting a radio quality of a channel is more than or equal to a predetermined threshold.

Clause 6: The method alone or in combination with the fifth clause, wherein the radio quality of the channel is based on one or more of: a reference signal received power (RSRP), a reference signal received quality (RSRQ), a reference signal strength indicator (RSSI), channel quality information (CQI), or a block error rate (BLER).

Clause 7: The method alone or in combination with the first clause, wherein the request is transmitted to the network entity via UE assistance information (UAI).

Clause 8: A method for wireless communication by a network entity, comprising: receiving, from a user equipment (UE), a request to change a connected mode discontinuous reception (CDRX) cycle that was generated by the UE after the UE detected one or more conditions at the UE are satisfied; and changing the CDRX cycle based on the request.

Clause 9: The method alone or in combination with the eighth clause, wherein the changing comprises disabling a first duration of the CDRX cycle based on the request, wherein a second duration of the CDRX cycle is longer than the first duration of the CDRX cycle.

Clause 10: The method alone or in combination with the ninth clause, wherein the UE detected the one or more conditions at the UE are satisfied comprises the UE detected the UE is configured with one or more parameters associated with the first mode of the CDRX cycle.

Clause 11: The method alone or in combination with the ninth clause, wherein the UE detected the one or more conditions at the UE are satisfied comprises the UE detected a duration of an inactivity timer is more than or equal to the first duration of the CDRX cycle.

Clause 12: The method alone or in combination with the eighth clause, wherein the UE detected the one or more conditions at the UE are satisfied comprises the UE detected a radio quality of a channel is more than or equal to a predetermined threshold.

Clause 13: The method alone or in combination with the twelfth clause, wherein the radio quality of the channel is based on one or more of: a reference signal received power (RSRP), a reference signal received quality (RSRQ), a reference signal strength indicator (RSSI), channel quality information (CQI), or a block error rate (BLER).

Clause 14: The method alone or in combination with the eighth clause, wherein the request is received via UE assistance information (UAI).

Clause 15: An apparatus, comprising: a memory comprising executable instructions; and one or more processors configured to execute the executable instructions and cause the apparatus to perform a method in accordance with any one of Clauses 1-14.

Clause 16: An apparatus, comprising means for performing a method in accordance with any one of Clauses 1-14.

Clause 17: A non-transitory computer-readable medium comprising executable instructions that, when executed by one or more processors of an apparatus, cause the apparatus to perform a method in accordance with any one of Clauses 1-14.

Clause 18: A computer program product embodied on a computer-readable storage medium comprising code for performing a method in accordance with any one of Clauses 1-14.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mm Wave frequencies, the BS 180 may be referred to as an mm Wave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 14 depicts an example disaggregated base station 1400 architecture. The disaggregated base station 1400 architecture may include one or more central units (CUs) 1410 that can communicate directly with a core network 1420 via a backhaul link, or indirectly with the core network 1420 through one or more disaggregated base station units (such as a Near-Real Time (Near-RT) RAN Intelligent Controller (RIC) 1425 via an E2 link, or a Non-Real Time (Non-RT) RIC 1415 associated with a Service Management and Orchestration (SMO) Framework 1405, or both). A CU 1410 may communicate with one or more distributed units (DUs) 1430 via respective midhaul links, such as an F1 interface. The DUs 1430 may communicate with one or more radio units (RUS) 1440 via respective fronthaul links. The RUs 1440 may communicate with respective UEs 104 via one or more radio frequency (RF) access links. In some implementations, the UE 104 may be simultaneously served by multiple RUs 1440.

Each of the units, i.e., the CUS 1410, the DUs 1430, the RUs 1440, as well as the Near-RT RICs 1425, the Non-RT RICs 1415 and the SMO Framework 1405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1410. The CU 1410 may be configured to handle user plane functionality (i.e., Central Unit-User Plane (CU-UP)), control plane functionality (i.e., Central Unit-Control Plane (CU-CP)), or a combination thereof. In some implementations, the CU 1410 can be logically split into one or more CU-UP units and one or more CU-CP units. The CU-UP unit can communicate bidirectionally with the CU-CP unit via an interface, such as the E1 interface when implemented in an O-RAN configuration. The CU 1410 can be implemented to communicate with the DU 1430, as necessary, for network control and signaling.

The DU 1430 may correspond to a logical unit that includes one or more base station functions to control the operation of one or more RUs 1440. In some aspects, the DU 1430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1430 may further host one or more low PHY layers. Each layer (or module) can be implemented with an interface configured to communicate signals with other layers (and modules) hosted by the DU 1430, or with the control functions hosted by the CU 1410.

Lower-layer functionality can be implemented by one or more RUs 1440. In some deployments, an RU 1440, controlled by a DU 1430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1440 can be implemented to handle over the air (OTA) communication with one or more UEs 104. In some implementations, real-time and non-real-time aspects of control and user plane communication with the RU(s) 1440 can be controlled by the corresponding DU 1430. In some scenarios, this configuration can enable the DU(s) 1430 and the CU 1410 to be implemented in a cloud-based RAN architecture, such as a vRAN architecture.

The SMO Framework 1405 may be configured to support RAN deployment and provisioning of non-virtualized and virtualized network elements. For non-virtualized network elements, the SMO Framework 1405 may be configured to support the deployment of dedicated physical resources for RAN coverage requirements which may be managed via an operations and maintenance interface (such as an O1 interface). For virtualized network elements, the SMO Framework 1405 may be configured to interact with a cloud computing platform (such as an open cloud (O-Cloud) 1490) to perform network element life cycle management (such as to instantiate virtualized network elements) via a cloud computing platform interface (such as an O2 interface). Such virtualized network elements can include, but are not limited to, CUs 1410, DUs 1430, RUs 1440 and Near-RT RICs 1425. In some implementations, the SMO Framework 1405 can communicate with a hardware aspect of a 4G RAN, such as an open eNB (O-eNB) 1411, via an O1 interface. Additionally, in some implementations, the SMO Framework 1405 can communicate directly with one or more RUs 1440 via an O1 interface. The SMO Framework 1405 also may include a Non-RT RIC 1415 configured to support functionality of the SMO Framework 1405.

The Non-RT RIC 1415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC X25. The Non-RT RIC 1415 may be coupled to or communicate with (such as via an A1 interface) the Near-RT RIC 1425. The Near-RT RIC 1425 may be configured to include a logical function that enables near-real-time control and optimization of RAN elements and resources via data collection and actions over an interface (such as via an E2 interface) connecting one or more CUs 1410, one or more DUs 1430, or both, as well as an O-eNB, with the Near-RT RIC 1425.

In some implementations, to generate AI/ML models to be deployed in the Near-RT RIC 1425, the Non-RT RIC 1415 may receive parameters or external enrichment information from external servers. Such information may be utilized by the Near-RT RIC 1425 and may be received at the SMO Framework 1405 or the Non-RT RIC 1415 from non-network data sources or from network functions. In some examples, the Non-RT RIC 1415 or the Near-RT RIC 1425 may be configured to tune RAN behavior or performance. For example, the Non-RT RIC 1415 may monitor long-term trends and patterns for performance and employ AI/ML models to perform corrective actions through the SMO Framework 1405 (such as reconfiguration via 01) or via creation of RAN management policies (such as A1 policies).

### Additional Considerations

The preceding description provides examples of managing a connected mode discontinuous reception (CDRX) cycle in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication by a user equipment (UE), comprising:
detecting one or more conditions are satisfied during a streaming session during which the UE buffers downlink data for playback; and
transmitting, to a network entity, a request to change a connected mode discontinuous reception (CDRX) cycle based on detecting the one or more conditions are satisfied.

2. The method of claim 1, further comprising receiving, from the network entity, a response indicating disablement of a first duration of the CDRX cycle, based on the request, wherein a second duration of the CDRX cycle is longer than the first duration of the CDRX cycle.

3. The method of claim 2, wherein detecting the one or more conditions are satisfied comprises: detecting the UE is configured with one or more parameters associated with the first duration of the CDRX cycle.

4. The method of claim 2, wherein detecting the one or more conditions are satisfied comprises: detecting a duration of an inactivity timer is more than or equal to the first duration of the CDRX cycle.

5. The method of claim 1, wherein detecting the one or more conditions are satisfied comprises: detecting a radio quality of a channel is more than or equal to a predetermined threshold.

6. The method of claim 5, wherein the radio quality of the channel is based on one or more of: a reference signal received power (RSRP), a reference signal received quality (RSRQ), a reference signal strength indicator (RSSI), channel quality information (CQI), or a block error rate (BLER).

7. The method of claim 1, wherein the request is transmitted to the network entity via UE assistance information (UAI).

8. An apparatus for wireless communication, comprising:
one or more memories comprising instructions; and
one or more processors configured to execute the instructions and cause the apparatus to:
detect one or more conditions are satisfied during a streaming session during which the apparatus buffers downlink data for playback; and
transmit, to a network entity, a request to change a connected mode discontinuous reception (CDRX) cycle based on detecting the one or more conditions are satisfied.

9. The apparatus of claim 8, wherein the one or more processors are configured to execute the instructions and cause the apparatus to to receive, from the network entity, a response indicating disablement of a first duration of the CDRX cycle, based on the request, wherein a second duration of the CDRX cycle is longer than the first duration of the CDRX cycle.

10. The apparatus of claim 9, wherein detecting the one or more conditions are satisfied comprises: detecting the apparatus is configured with one or more parameters associated with the first duration of the CDRX cycle.

11. The apparatus of claim 9, wherein detecting the one or more conditions are satisfied comprises: detecting a duration of an inactivity timer is more than or equal to the first duration of the CDRX cycle.

12. The apparatus of claim 8, wherein detecting the one or more conditions are satisfied comprises: detecting a radio quality of a channel is more than or equal to a predetermined threshold.

13. The apparatus of claim 12, wherein the radio quality of the channel is based on one or more of: a reference signal received power (RSRP), a reference signal received quality (RSRQ), a reference signal strength indicator (RSSI), channel quality information (CQI), or a block error rate (BLER).

14. The apparatus of claim 8, wherein the request is transmitted to the network entity via user equipment (UE) assistance information (UAI).

15. The apparatus of claim 8, further comprising a transceiver configured to transmit the request to change the CDRX cycle, wherein the apparatus is configured as a user equipment (UE).

16. A non-transitory computer-readable medium comprising instructions that, when executed by one or more processors of a user equipment (UE), cause the UE to perform a method of wireless communications, comprising:
detecting one or more conditions are satisfied during a streaming session during which the UE buffers downlink data for playback; and
transmitting, to a network entity, a request to change a connected mode discontinuous reception (CDRX) cycle based on detecting the one or more conditions are satisfied.

17. The non-transitory computer-readable medium of claim 16, wherein the method further comprises receiving, from the network entity, a response indicating disablement of a first duration of the CDRX cycle, based on the request, wherein a second duration of the CDRX cycle is longer than the first duration of the CDRX cycle.

18. The non-transitory computer-readable medium of claim 17, wherein detecting the one or more conditions are satisfied comprises: detecting the UE is configured with one or more parameters associated with the first duration of the CDRX cycle.

19. The non-transitory computer-readable medium of claim 17, wherein detecting the one or more conditions are satisfied comprises: detecting a duration of an inactivity timer is more than or equal to the first duration of the CDRX cycle.

20. The non-transitory computer-readable medium of claim 16, wherein detecting the one or more conditions are satisfied comprises: detecting a radio quality of a channel is more than or equal to a predetermined threshold.

21. (canceled)

22. (canceled)

23. (canceled)

24. (canceled)

25. (canceled)

26. (canceled)

27. (canceled)

28. (canceled)

29. (canceled)

30. (canceled)
